(19) United States
(12) Patent Application Publication
(10) Pub. No.: US 2013/0286330 A1
(43) Pub. Date: Oct. 31, 2013

(54) OPTICAL FILM AND LIQUID CRYSTAL DISPLAY INCLUDING THE SAME

(71) Applicants: Moon-Yeon LEE, Uiwang-si (KR); Hyeon CHO, Uiwang-si (KR); Hyun-Gi KIM, Uiwang-si (KR); Hae-Ryong CHUNG, Uiwang-si (KR); Jong-Gyu LA, Uiwang-si (KR)

(72) Inventors: Moon-Yeon LEE, Uiwang-si (KR); Hyeon CHO, Uiwang-si (KR); Hyun-Gi KIM, Uiwang-si (KR); Hae-Ryong CHUNG, Uiwang-si (KR); Jong-Gyu LA, Uiwang-si (KR)

(21) Appl. No.: 13/931,835

(22) Filed: Jun. 29, 2013

Related U.S. Application Data
(63) Continuation of application No. PCT/KR2011/009273, filed on Dec. 1, 2011.

(30) Foreign Application Priority Data
Dec. 30, 2010 (KR) 10-2010-0139072

(51) Int. Cl. G02F 1/13363; G02B 1/08; G02B 5/30

(52) U.S. Cl. CPC G02F 1/133634; G02B 5/3083; G02B 1/08
USPC 349/96; 359/489.02

(57) ABSTRACT

An optical film and a liquid crystal display including the same, the optical film including a first compensation layer having a relation of n1z>n1x>n1y between indexes of refraction n1x, n1y, and n1z in x-axis, y-axis, and z-axis directions on a plane; and a second compensation layer having a relation of n2x>n2y>n2z between indexes of refraction n2x, n2y, and n2z in x-axis, y-axis, and z-axis directions on a plane.

### CROSS-REFERENCE TO RELATED APPLICATIONS

This application is a continuation of pending International Application No. PCT/KR2011/009273, entitled “Optical Film and Liquid Crystal Display Including the Same,” which was filed on Dec. 1, 2011, the entire contents of which are hereby incorporated by reference.

Korean Patent Application No. 10-2010-0139072, filed on Dec. 30, 2010, in the Korean Intellectual Property Office, and entitled: “Optical Film and Liquid Crystal Display Including the Same,” is incorporated by reference herein in its entirety.

### BACKGROUND

1. Field

Embodiments relate to an optical film and a liquid crystal display including the same.

2. Description of the Related Art

A liquid crystal display (LCD) is a widely used flat panel display. A liquid crystal display may include a liquid crystal layer encapsulated between a thin film transistor (TFT) array substrate and a color filter substrate. The liquid crystal display displays an image based on variation of arrangement of liquid crystal molecules in the liquid crystal layer upon application of an electric field to electrodes on the array substrate and the color filter substrate.

### SUMMARY

Embodiments are directed to an optical film and a liquid crystal display including the same

The embodiments may be realized by providing an optical film including a first compensation layer having a relation of n1z>n1x>n1y between indexes of refraction n1x, n1y, and n1z in x-axis, y-axis, and z-axis directions on a plane; and a second compensation layer having a relation of n2x>n2y>n2z between indexes of refraction n2x, n2y, and n2z in x-axis, y-axis, and z-axis directions on a plane.

The first compensation layer may include a film obtained by stretching a copolymer of a first repeat unit and a second repeat unit, the first repeat unit including an N-substituted maleimide monomer, an aromatic vinyl monomer, and a maleic anhydride monomer, and the second repeat unit including an aromatic vinyl monomer and a vinyl cyanide monomer.

The first compensation layer may include a film obtained by stretching a copolymer represented by Formula 1:

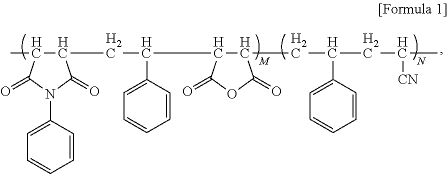

wherein M and N are natural numbers, and M:N may be 5:5 to 7:3.

The first compensation layer may include a film obtained by stretching a copolymer of an aromatic vinyl monomer and a maleic anhydride monomer.

The first compensation layer may include a film obtained by stretching a copolymer represented by Formula 2:

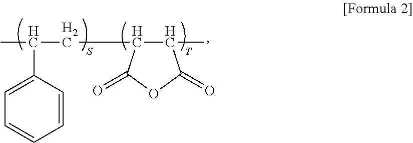

wherein S and T are natural numbers, and S:T may be 8:2 to 7:3.

The first compensation layer may have Re of 90 nm to 150 nm at a wavelength of 550 nm.

The first compensation layer may have Rth of 100 nm to 140 nm at a wavelength of 550 nm.

The first compensation layer may have Nz of −1.0 to −0.5 at a wavelength of 550 nm.

The second compensation layer may include a cellulose or COP film.

The optical film may further include a polarizing layer stacked on one surface of the second compensation layer.

The embodiments may also be realized by providing a liquid crystal display including a liquid crystal panel including liquid crystals encapsulated between a first substrate and a second substrate; a first optical film including a compensation layer, the compensation layer including a first compensation layer and a second compensation layer stacked on one surface of the first substrate, and a first polarizing layer stacked on one surface of the compensation layer; and a second optical film including a second polarizing layer stacked on one surface of the second substrate, wherein the first compensation layer has a relation of n1z>n1x>n1y between indexes of refraction n1x, n1y, and n1z in x-axis, y-axis, and z-axis directions on a plane, and the second compensation layer has a relation of n2x>n2y>n2z between indexes of refraction n2x, n2y, n2z in x-axis, y-axis, and z-axis directions on a plane.

The first compensation layer may include a film obtained by stretching a copolymer of a first repeat unit and a second repeat unit, the first repeat unit including an N-substituted maleimide monomer, an aromatic vinyl monomer, and a maleic anhydride monomer, and the second repeat unit including an aromatic vinyl monomer and a vinyl cyanide monomer.

The first compensation layer may include a film obtained by stretching a copolymer represented by Formula 1:

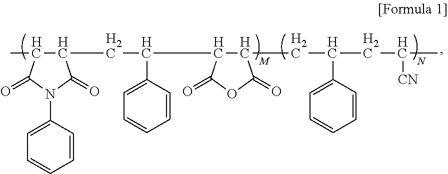

wherein M and N are natural numbers, and M:N may be 5:5 to 7:3.

The first compensation layer may include a film obtained by stretching a copolymer of an aromatic vinyl monomer and a maleic anhydride monomer.

The first compensation layer may include a film obtained by stretching a copolymer represented by Formula 2:

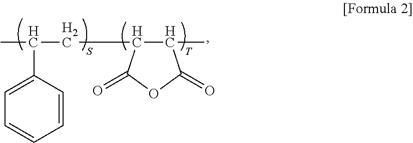

wherein S and T are natural numbers, and S:T may be 8:2 to 7:3.

The first compensation layer may have Re of 90 nm to 150 nm at a wavelength of 550 nm.

The first compensation layer may have Rth of 100 nm to 140 nm at a wavelength of 550 nm.

The first compensation layer may have Nz of −1.0 to −0.5 at a wavelength of 550 nm.

A retardation axis of the first compensation layer, a retardation axis of the second compensation layer, and a transmission axis of the first polarizing layer may be parallel to one another.

The second compensation layer may include a cellulose or COP film.

The liquid crystals may be in-plane switching mode liquid crystals or fringe field switching mode liquid crystals.

### BRIEF DESCRIPTION OF DRAWINGS

Features will become apparent to those of skill in the art by describing in detail exemplary embodiments with reference to the attached drawings in which:

FIG. 1 illustrates a sectional view of a liquid crystal display in accordance with one embodiment;

FIG. 2 illustrates an exploded perspective view of optical axes of a first optical film of the liquid crystal display of FIG. 1;

FIG. 3 illustrates a schematic sectional view of stages in a method of applying an optical film for a vertical alignment mode to an optical film for an in-plane or fringe field switching mode; and

FIG. 4 to FIG. 6 illustrate brightness of liquid crystal displays of Example 1, Example 2, and Comparative Example 1 in a black state.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

One embodiment relates to an optical film. The optical film may include a first compensation layer and a second compensation layer.

The optical film may include a first compensation layer having a relation of n1z>n1x>n1y between indexes of refraction n1x, n1y, and n1z, respectively in x-axis, y-axis, and z-axis directions on a plane, and a second compensation layer having a relation of n2x>n2y>n2z between indexes of refraction n2x, n2y, and n2z, respectively in x-axis, y-axis, and z-axis directions on a plane.

In the optical film, the second compensation layer may be stacked on one surface of the first compensation layer.

The optical film may be a compensation film in a polarizing plate for a liquid crystal display. For example, the optical film may be a compensation film in a polarizing plate used for a liquid crystal display, which may include in-plane or fringe field switching mode liquid crystals or vertical alignment mode liquid crystals.

In an implementation, the optical film may further include, e.g., a polarizing layer, a protective layer, or the like. For example, the second compensation layer may be formed on the first compensation layer, the polarizing layer may be formed on the second compensation layer, and the protective layer may be formed on the polarizing layer.

The first compensation layer may include a film obtained by stretching a copolymer of an N-substituted maleimide monomer, an aromatic vinyl monomer, a maleic anhydride monomer, and a vinyl cyanide monomer, e.g., a polyimide copolymer.

The N-substituted maleimide monomer may include, e.g., a maleimide substituted with a C1-C10 alkyl group, a C6-C20 aryl group, or a C6-C20 aralkyl group comprising C7-C20 aralkyl group. For example, the N-substituted maleimide monomer may include a maleimide substituted with a C6-C20 aryl group.

The aromatic vinyl monomer may include, e.g., styrene, vinyl naphthalene or vinyl anthracene. In an implementation, the aromatic vinyl monomer may include styrene.

The maleic anhydride monomer may include, e.g., maleic anhydride.

The vinyl cyanide monomer may include, e.g., acrylonitrile or methacrylonitrile.

The first compensation layer may be a film obtained by stretching a copolymer of a first repeat unit (A) and a second repeat unit (B). For example, the first repeat unit (A) may be composed of or may include an N-substituted maleimide monomer (a1), an aromatic vinyl monomer (a2), and a maleic anhydride monomer (a3), and the second repeat unit (B) may be composed of or may include an aromatic vinyl monomer (b1) and a vinyl cyanide monomer (b2).

In the first repeat unit (A), an arrangement sequence of the monomer (a1), the monomer (a2), and the monomer (a3) may be changed or varied.

For example, the first repeat unit (A) may have an arrangement sequence of the monomers (a1)-(a2)-(a3), the monomers (a1)-(a3)-(a2), the monomers (a2)-(a3)-(a1), the monomers (a2)-(a1)-(a3), the monomers (a3)-(a2)-(a1), or the monomers (a3)-(a1)-(a2).

In the first compensation layer, the first repeat unit (A) and the second repeat unit (B) may be polymerized in a molar ratio of 5:5 to 7:3. For example, in the first compensation layer, the first repeat unit (A) and the second repeat unit (B) may be present in the copolymer in a molar ratio of 5:5 to 7:3.

For example, the copolymer included in the first compensation layer may be represented by Formula 1, below.

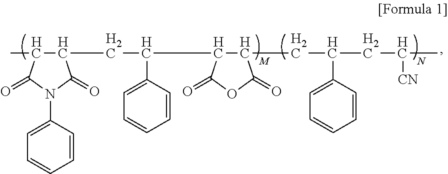

In Formula 1, M and N are natural numbers, and M:N may be 5:5 to 7:3.

For example, M may be in the range of 120,000 to 150,000, and N may be in the range of 100,000 to 150,000.

In an implementation, the first compensation layer may be a film obtained by stretching a copolymer of an aromatic vinyl monomer and a maleic anhydride monomer. For example, the first compensation layer may be a film obtained by stretching a copolymer represented by Formula 2, below.

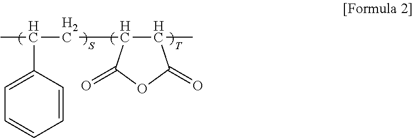

In Formula 2, S and T are natural numbers, and S:T may be 8:2 to 7:3. For example, S may be in the range of 200,000 to 250,000, and T may be in the range of 50,000 to 100,000.

The second compensation layer may be or may include one selected from the group of cellulose including triacetyl cellulose (TAC), cellulose acetate propionate (CAP), and the like; cyclo-olefin polymer (COP) resins, polynorbornene resins, polycarbonate resins, polyester resins, polyethersulfone resins, polysulfone resins, polyamide resins, polyimide resins, polyolefin resins, polyacrylate resins, polyvinyl alcohol resins, polyvinyl chloride resins, and polyvinylidene chloride resins; and combinations thereof. In an implementation, the second compensation layer may include a cellulose or COP film.

According to a number of optical axes, the compensation film may be classified into a uniaxial type (which has a single optical axis) and a biaxial type (which has two optical axes). The compensation film may also be classified into a positive type and a negative type, according to a relation between an index of refraction in a direction of the optical axis and an index of refraction in another direction. For example, when the index of refraction in the direction of the optical axis is greater than the index of refraction in another direction, the compensation film is a positive film, and when the index of refraction in the direction of the optical axis is less than the index of refraction in another direction, the compensation film is a negative film.

The compensation film for liquid crystal displays may have phase retardation values, and may serve to cancel or add phase retardation caused by liquid crystals. The phase retardation values include an in-plane phase retardation value (Re) and a phase retardation value (Rth) in a thickness direction. Re and Rth may be obtained by the following Equation 1.

Re=(nx−ny)xd

Rth=((nx+ny)/2−nz)×d [Equation 1]

In Equation 1, nx, ny, and nz are indexes of refraction in x-axis, y-axis, and z-axis (thickness) directions, respectively, and d represents the thickness of a film.

Nz, representing the degree of biaxiality with regard to the phase retardation value, may be obtained by the following Equation 2.

Nz=(nx−nz)/(nx−ny) [Equation 2]

In Equation 2, nx, ny, nz are indexes of refraction in the x-axis, y-axis, and z-axis (thickness) directions, respectively.

In an implementation, in the optical film, the first compensation layer may be a negative biaxial film, in which Re is in the range of 90 nm to 150 nm, Rth is in the range of 100 nm to 140 nm, and Nz is in the range of −1.0 to −0.5, as obtained at a wavelength of 550 nm.

In an implementation, in the optical film, the second compensation layer may be a positive biaxial film, in which Re is in the range of 40 nm to 60 nm and Rth is in the range of −130 nm to 110 nm, as obtained at a wavelength of 550 nm.

Within these ranges, when the first compensation layer and the second compensation layer are stacked to have retardation axes parallel to each other, it is possible to achieve substantial improvement of side viewing angle. For example, the optical film according to an embodiment may be very effective in compensating for the viewing angle of in-plane switching mode liquid crystals.

The first compensation layer and the second compensation layer may be realized in the form of films, and may be combined with each other to form an optical film. In an implementation, the first compensation layer may have a thickness in the range of 5 μm to 100 and the second compensation layer may have a thickness in the range of 5 μm to 100 μm. These thicknesses may be suitably changed according to the indexes of refraction of materials constituting the corresponding compensation layers, the kind of liquid crystal panel on which the optical film will be mounted, and the like.

Another embodiment relates to a liquid crystal display including the optical film.

The liquid crystal display according to an embodiment may include a liquid crystal panel (including liquid crystals encapsulated between a first substrate and a second substrate); a first optical film (including a first compensation layer and a second compensation layer stacked on one surface of the first substrate); and a second optical film (stacked on one surface of the second substrate). The first compensation layer may have a relation of n1z>n1x>n1y between indexes of refraction n1x, n1y, and n1z in x-axis, y-axis, and z-axis directions on a plane, and the second compensation layer may have a relation of n2x>n2y>n2z between indexes of refraction n2x, n2y, and n2z in x-axis, y-axis, and z-axis directions on a plane.

For example, the first compensation layer and the second compensation layer may be the same as those described above.

In the first optical film, the first compensation layer and the second compensation layer may be sequentially stacked on the first substrate in this order.

The first optical film may further include a first polarizing layer and a first protective layer sequentially stacked on the second compensation layer. For example, the first optical film may be an optical film separated from a polarizing layer (polarizer or polarizing plate), or an optical film further including a polarizing layer and a protective layer. For example, in the first optical film, the first compensation layer may be stacked on the first substrate, the second compensation layer may be stacked on the first compensation layer, the first polarizing layer may be stacked on the second compensation layer, and the first protective layer may be stacked on the first polarizing layer.

The second optical film may be a suitable polarizing film. The second optical film may include a second polarizing layer, and may further include a second protective layer and a third protective layer. For example, in the second optical film, the second protective layer may be stacked on one surface of the second substrate, the second polarizing layer may be stacked on the second protective layer, and the third protective layer may be stacked on the second polarizing layer.

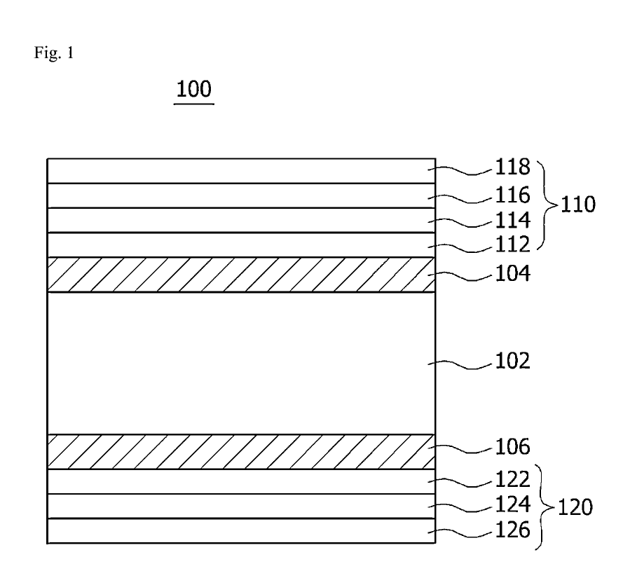

FIG. 1 illustrates a sectional view of a liquid crystal display in accordance with one embodiment.

Referring to FIG. 1, the liquid crystal display 100 according to this embodiment may include a liquid crystal panel 102, which may include a liquid crystal layer encapsulated between a first substrate 104 and a second substrate 106. A first optical film 110 may be stacked on one surface of the first substrate 104 (e.g., on an upper surface thereof), and a second optical film 120 may be stacked on one surface of the second substrate 106 (e.g., on a lower surface thereof). Herein, the terms “upper (surface)” and “lower (surface)” are used for convenience of description with reference to the drawings, and should not be construed as meaning only upper and lower portions, respectively.

The first substrate 104 and the second substrate 106 may be, e.g., glass substrates or plastic substrates. The plastic substrate may include at least one selected from polyethylene terephthalate (PET), polycarbonate (PC), polyimide (PI), polyethylene naphthalate (PEN), polyether sulfone (PES), polyacrylate (PAR), and cycloolefin copolymer (COC), which may be used for a flexible display, without being limited thereto.

The first optical film 110 may include a first compensation layer 112 and a second compensation layer 114, and may further include a first polarizing layer 116 and a first protective layer 118 stacked on an upper surface of the second compensation layer 114 in this order.

The first compensation layer 112 may have a relation of n1z>n1x>n1y between indexes of refraction n1x, n1y, and n1z in x-axis, y-axis, and z-axis directions on a plane. The second compensation layer 114 may have a relation of n2x>n2y>n2z between indexes of refraction n2x, n2y, and n2z in x-axis, y-axis, and z-axis directions on a plane.

The first compensation layer 112 may have Re in the range of 90 nm to 150 nm, Rth in the range of 100 nm to 140 nm, and Nz in the range of −1.0 to −0.5, as obtained at a wavelength of 550 nm. The second compensation layer 114 may have Re in the range of 40 nm to 60 nm, and Rth in the range of −130 nm to 110 nm, as obtained at a wavelength of 550 nm.

The first polarizing layer 116 may include a polarizer obtained by stretching a polyvinyl alcohol (PVA) film dyed with a dichroic material such as iodine. The polyvinyl alcohol film may be selected from among any commercially available polyvinyl alcohol films. Alternatively, the polyvinyl alcohol film may be produced by solvent casting, melt extrusion, or the like. In solvent casting, a resin solution prepared by dissolving a resin in a solvent is coated on a casting roll or belt, followed by evaporation of the solvent, thereby producing a desired film. In melt extrusion, a resin is melted at a melting point or more, followed by extrusion and cooling through cooling rolls, thereby producing a desired film. A solution for preparing the film may further include a plasticizer for enhancing flexibility of the polyvinyl alcohol film and a surfactant for facilitating separation of the dried polyvinyl alcohol film from a belt or drum. The polarizer (polarizing layer) may be manufactured by stretching the prepared polyvinyl alcohol film or any suitable commercially available polyvinyl alcohol film. For example, the polarizer (polarizing layer) may be manufactured through washing/swelling, dyeing, cross-linking, stretching and coloring the polyvinyl alcohol film.

The polarizer may have long hydrocarbon side chains, which may be arranged in the stretched direction of the polyvinyl alcohol film and may exhibit conductivity due to iodine molecules dyed thereto. For example, a light component having an electrical field vector parallel to the side chains is absorbed thereby, the stretched direction becomes an absorption axis along which light is absorbed by the film, and the direction perpendicular to the absorption axis becomes a transmission axis.

The first protective layer 118 may be composed of or may include, e.g., cellulose films, such as triacetyl cellulose (TAC) and cellulose acetate propionate (CAP) films, polycarbonate, polyamide, polyimide, polyolefin, polyester, polyetersulfone, or polypropylene films. For example, the first protective layer 118 may be a TAC film.

The second optical film 120 may include a second polarizing layer 124, and may further include a second protective layer 122 (stacked on upper surface of the second polarizing layer 124) and a third protective layer 126 (stacked on lower surface of the second polarizing layer 124). The second polarizing layer 124 may be formed of the same material and by the same method as the first polarizing layer 116. For example, the second polarizing layer 124 and the first polarizing layer 116 may be subjected to cutting such that the polarizing axes thereof are arranged at 90 degrees with respect to each other.

The second and third protective layers 122, 126 may be composed of or may include, e.g., cellulose films, such as triacetyl cellulose (TAC) and cellulose acetate propionate (CAP) films, polycarbonate, polyamide, polyimide, polyolefin, polyester, polyestersulfone, or polypropylene films. For example, the second and third protective layers 122, 126 may include TAC films.

The liquid crystal layer may include twisted nematic (TN), super twisted nematic (STN), in-plane switching (IPS), super-IPS, fringe field switching (FFS), or vertical alignment (VA) mode liquid crystals. For example, IPS mode liquid crystals may provide excellent phase retardation effects.

Each of the first and second compensation layers 112, 114 may have a retardation axis and a fast axis, which are perpendicular to the traveling direction of light and orthogonal to each other. The first and second compensation layers 112, 114 may serve to change the phase velocity of incident light, and the velocity of a light component polarized along the retardation axis may be slower than that of a light component polarized along the fast axis.

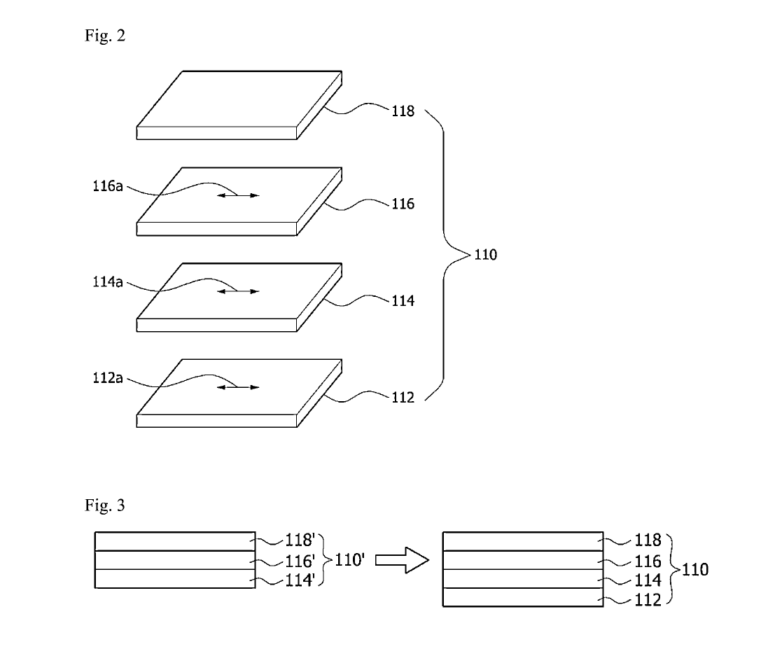

FIG. 2 illustrates an exploded perspective view of optical axes of the first optical film of the liquid crystal display of FIG. 1.

Referring to FIG. 2, in the first optical film 110 according to this embodiment, a retardation axis 112a of the first compensation layer 112 may be parallel to a retardation axis 114a of the second compensation layer 114. In an implementation, when the optical film further includes a first polarizing layer 116, the retardation axes 112a, 114a of the first and second compensation layers may be arranged parallel to a transmission axis 116a of the first polarizing layer 116. For example, a relation between the indices of refraction thereof may be nx>nz>ny, and may help increase a viewing angle of in-plane switching mode or fringe field switching mode liquid crystals, thereby providing excellent phase retardation effects.

FIG. 3 illustrates a schematic sectional view of stages in a method of applying an optical film for a vertical alignment mode to an optical film for an in-plane or fringe field switching mode.

As shown in FIG. 3, an optical film 110′ for a vertical alignment mode may include a polarizer 116′, a protective film 118′ stacked on upper surface of the polarizer 116′, and a compensation film 114′ stacked on lower surface of the polarizer 116′ and has positive biaxiality. The optical film 110′ may be referred to as a polarizing plate.

The compensation film 114′ may be composed of or may include, e.g., a TAC or COP film. In an implementation, the TAC film may be used as the compensation film. The TAC film may contain various additives for facilitating exhibition of phase difference and prepared by stretching. Examples of commercially available TAC films include N-TAC (KONICA), V-TAC (FUJI), and the like.

However, the kind and manufacturing process of the compensation film may differ according to the liquid crystal modes, causing an increase in manufacturing costs. The first compensation layer (which is a negative biaxial film according to the present embodiment as represented by Formulas 1 and 2) may exhibit good adhesion to the compensation film 114′ for the vertical alignment mode. Accordingly, the compensation film according to an embodiment may help prevent separation of a phase difference film during reworking. Thus, the optical film including the first compensation layer may exhibit good processibility and may be easily used as an optical film for the in-plane or fringe field switching mode.

Since a negative biaxial compensation film, e.g., the first compensation layer 112, may be easily stacked on the lower side of the compensation film 114′, the first optical film 110 constituted by the first compensation layer 112, the second compensation layer 114, the first polarizing layer 116 and the first protective layer 118 may be easily realized.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

As the first compensation layer, a polyimide copolymer resin having negative biaxiality (KX-359, Denka Co., Ltd.) was longitudinally stretched to prepare a 40 μm thick film having Re of 98 nm, Rth of 132 nm, and Nz of −1.0 at a wavelength of 550 nm. As the second compensation layer, a 48 μm thick triacetyl cellulose film having positive biaxiality was used. This triacetyl cellulose film had Re of 50 nm and Rth of −120 nm at a wavelength of 550 nm. With these two compensation layers stacked on a first substrate (color filter substrate) to have retardation axes parallel to the transmission axis of the polarizer, characteristics of the LCD panel were analyzed.

### Example 2

As the first compensation layer, a polyimide copolymer resin having negative biaxiality (KX-359, Denka Co., Ltd.) was longitudinally stretched to prepare a 40 μm thick film having Re of 125 nm, Rth of 140 nm, and Nz of −1.0 at a wavelength of 550 nm. As the second compensation layer, a 48 μm thick triacetyl cellulose film having positive biaxiality was used. This triacetyl cellulose film had Re of 50 nm and Rth of −120 nm at a wavelength of 550 nm. With these two compensation layers stacked on a first substrate (color filter substrate) to have retardation axes parallel to the transmission axis of the polarizer, characteristics of the LCD panel were analyzed.

### Example 3

As the first compensation layer, a copolymer resin of maleic anhydride and styrene having negative biaxiality (Ryulex A-14, DIC Co., Ltd.) was longitudinally stretched to prepare a 40 μm thick film having Re of 99 nm, Rth of 132 nm, and Nz of −0.8 at a wavelength of 550 nm. As the second compensation layer, a 48 μm thick triacetyl cellulose film having positive biaxiality was used. This triacetyl cellulose film had Re of 50 nm and Rth of −120 nm at a wavelength of 550 nm. With these two compensation layers stacked on a first substrate (color filter substrate) to have retardation axes parallel to the transmission axis of the polarizer, characteristics of the LCD panel were analyzed.

### Example 4

As the first compensation layer, a copolymer resin of maleic anhydride and styrene having negative biaxiality (Ryulex A-14, DIC Co., Ltd.) was longitudinally stretched to prepare a 40 μm thick film having Re of 125 nm, Rth of 140 nm, and Nz of −0.8 at a wavelength of 550 nm. As the second compensation layer, a 48 μm thick triacetyl cellulose film having positive biaxiality was used. This triacetyl cellulose film had Re of 50 nm and Rth of −120 nm at a wavelength of 550 nm. With these two compensation layers stacked on a first substrate (color filter substrate) to have retardation axes parallel to the transmission axis of the polarizer, characteristics of the LCD panel were analyzed.

### Comparative Example 1

A 48 μm thick triacetyl cellulose film having positive biaxiality was used. This triacetyl cellulose film had Re of 50 nm and Rth of −120 nm at a wavelength of 550 nm. With this compensation layer stacked on a first substrate (color filter substrate), characteristics of the LCD panel were analyzed.

### Comparative Example 2

As the first compensation layer, a polyimide copolymer resin having negative biaxiality (KX-359, Denka Co., Ltd.) was longitudinally stretched to prepare a 40 μm thick film having Re of 98 nm, Rth of 132 nm, and Nz of −1.0 at a wavelength of 550 nm. As the second compensation layer, a 48 μm thick triacetyl cellulose film having positive biaxiality was used. This triacetyl cellulose film had Re of 50 nm and Rth of −120 nm at a wavelength of 550 nm. With these two compensation layers stacked on a first substrate (color filter substrate) to have retardation axes perpendicular to the transmission axis of the polarizer, characteristics of the LCD panel were analyzed.

### Comparative Example 3

As the first compensation layer, a copolymer resin of maleic anhydride and styrene having negative biaxiality (Ryulex A-14, DIC Co., Ltd.) was longitudinally stretched to prepare a 40 μm thick film having Re of 99 nm, Rth of 132 nm, and Nz of −0.8 at a wavelength of 550 nm. As the second compensation layer, a 48 μm thick triacetyl cellulose film having positive biaxiality was used. This triacetyl cellulose film had Re of 50 nm and Rth of −120 nm at a wavelength of 550 nm. With these two compensation layers stacked on a first substrate (color filter substrate) to have retardation axes perpendicular to the transmission axis of the polarizer, characteristics of the LCD panel were analyzed.

### Comparative Example 4

As the first compensation layer, a copolymer resin of maleic anhydride and styrene having negative biaxiality (Ryulex A-14, DIC Co., Ltd.) was longitudinally stretched to prepare a 40 μm thick film having Re of 85 nm, Rth of 110 nm, and Nz of −0.8 at a wavelength of 550 nm. As the second compensation layer, a 48 μm thick triacetyl cellulose film having positive biaxiality was used. This triacetyl cellulose film had Re of 50 nm and Rth of −120 nm at a wavelength of 550 nm. With these two compensation layers stacked on a first substrate (color filter substrate) to have retardation axes parallel to the transmission axis of the polarizer, characteristics of the LCD panel were analyzed.

Measurement of Optical Characteristics

Brightness in a white state and a black state were measured using white light with a brightness tester SR 3 of Topcon Co., Ltd.

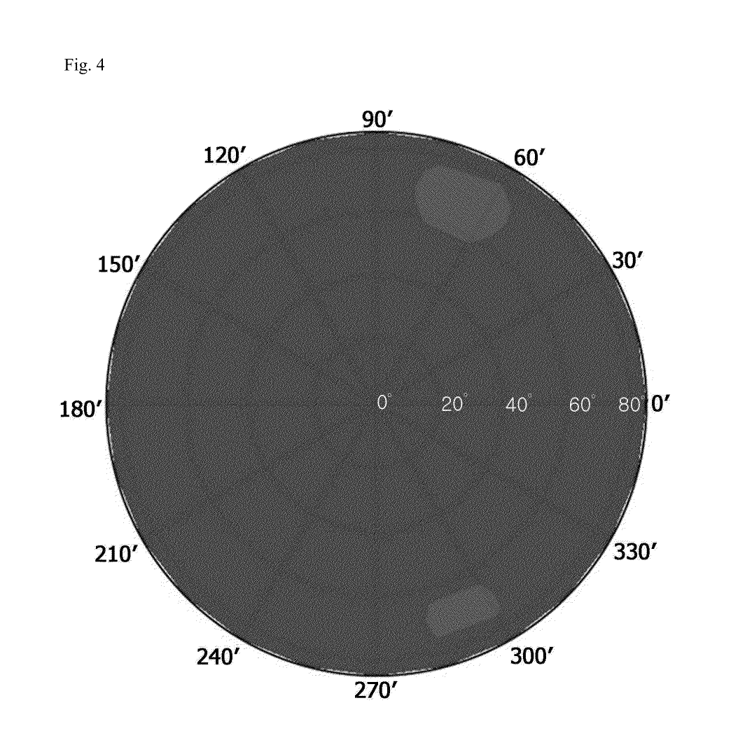

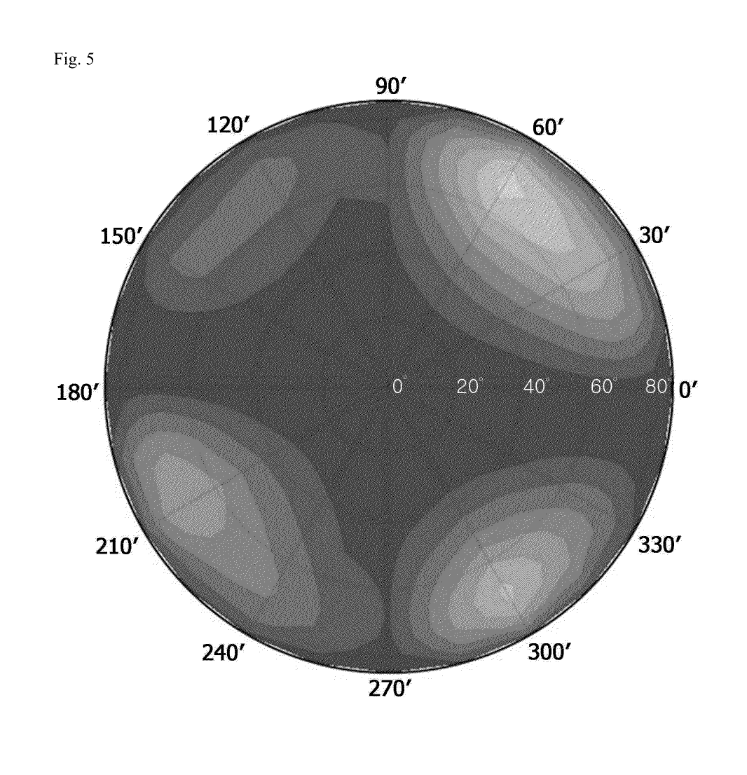

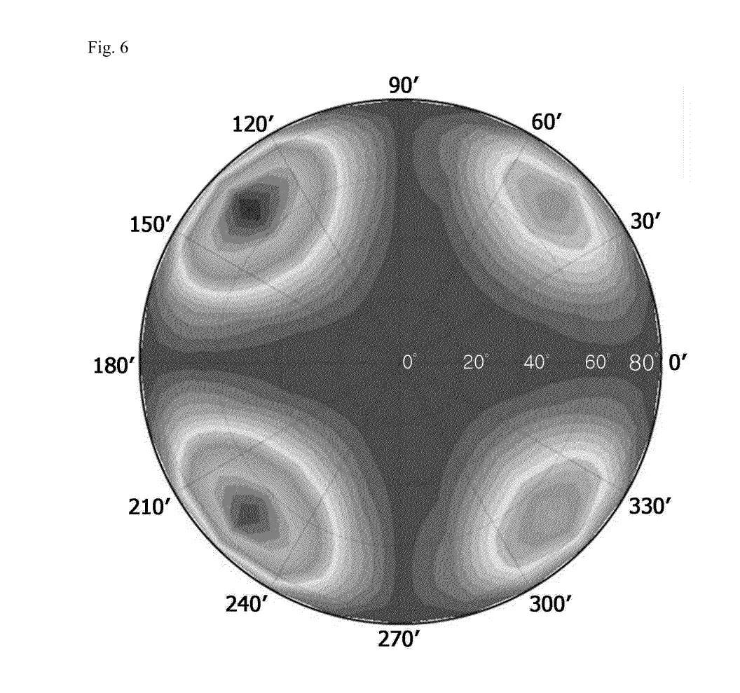

FIG. 4 to FIG. 6 illustrate brightness of liquid crystal displays of Example 1, Example 2, and Comparative Example 1 in a black state. The following Table 1 shows a side (inclined angle) contrast ratio (white state brightness/black state brightness) at an azimuth angle (Φ) of 45 degrees and a polar angle (θ) of 60 degrees.

TABLE 1

| | Side contrast ratio |
|---|---|
| Example 1 | 131 |
| Example 2 | 125 |
| Example 3 | 128 |
| Example 4 | 124 |
| Comparative | 50 |
| Example 1 | |
| Comparative | 54 |
| Example 2 | |
| Comparative | 58 |
| Example 3 | |
| Comparative | 112 |
| Example 4 | |

In FIG. 4 to FIG. 6, a portion represented by a dark gray color indicates low brightness and a portion represented by a lighter gray color indicates high brightness, which increases with increasing color density. Thus, it may be seen that Examples 1 and 2 had lower brightness in substantially all directions, as compared to Comparative Example 1. This result means that the contrast ratio represented by the ratio of white state brightness to black state brightness increases.

Furthermore, as may be seen from Table 1, Examples 1 to 4 had significantly improved side contrast ratio, as compared with Comparative Examples 1 to 4. For example, Examples 1 to 4 exhibited an average side contrast ratio of 127, which was about 68% higher than an average side contrast ratio of 75.4 of Comparative Examples 1 to 4.

By way of summation and review, a liquid crystal display may include polarizing films (or polarizing plates) outside the array substrate and the color filter substrate. The polarizing film may facilitate selective transmission of light traveling in a specific direction among light entering from a backlight unit and light passing through the liquid crystal layer, thereby achieving polarization. The polarizing plate may include a polarizer capable of polarizing light in a specific direction and a protective layer for supporting and protecting the polarizer.

The liquid crystal display may have a reduced viewing angle due to anisotropy of the index of refraction of liquid crystals. Wide viewing angle techniques, e.g., a vertical alignment (VA) mode, an in-plane switching (IPS) mode, a fringe field switching (FFS) mode, or the like, may be used to help improve the viewing angle of a twisted nematic (TN) mode LCD. However, such a wide viewing angle technique may not fundamentally solve viewing angle issues. Thus, a compensation film (e.g., a retardation film) may be used to help improve viewing angle.

The VA mode, the IPS mode, and the FFS mode may employ different kinds of liquid crystals, and may have different physical and optical properties, e.g., index of refraction, alignment orientation, or the like. Accordingly, the compensation film for improving viewing angle may demonstrate completely different characteristics when applied to, e.g., the VA mode and the IPS or FFS modes. Thus, the polarizing plate including such a compensation film may be separately manufactured, causing concerns in mass production and management and the possibility of increased manufacturing costs. Moreover, a compensation film capable of solving viewing angle issues is desirable.

The embodiments provide an optical film and a liquid crystal display including the same, which may help improve viewing angle and may facilitate mass production and a reduction in manufacturing costs.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An optical film, comprising:
a first compensation layer having a relation of n1z>n1x>n1y between indexes of refraction n1x, n1y, and n1z in x-axis, y-axis, and z-axis directions on a plane; and
a second compensation layer having a relation of n2x>n2y>n2z between indexes of refraction n2x, n2y, and n2z in x-axis, y-axis, and z-axis directions on a plane.

2. The optical film as claimed in claim 1, wherein the first compensation layer includes a film obtained by stretching a copolymer of a first repeat unit and a second repeat unit, the first repeat unit including an N-substituted maleimide monomer, an aromatic vinyl monomer, and a maleic anhydride monomer, and the second repeat unit including an aromatic vinyl monomer and a vinyl cyanide monomer.

3. The optical film as claimed in claim 1, wherein the first compensation layer includes a film obtained by stretching a copolymer represented by Formula 1: 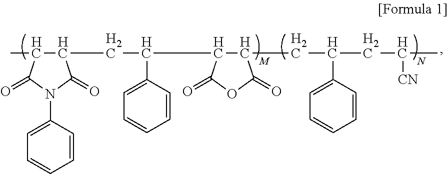
wherein M and N are natural numbers, and M:N is 5:5 to 7:3.

4. The optical film as claimed in claim 1, wherein the first compensation layer includes a film obtained by stretching a copolymer of an aromatic vinyl monomer and a maleic anhydride monomer.

5. The optical film as claimed in claim 1, wherein the first compensation layer includes a film obtained by stretching a copolymer represented by Formula 2: 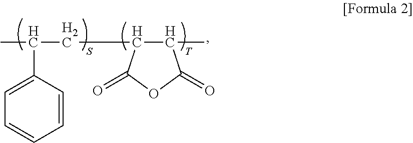
wherein S and T are natural numbers, and S:T is 8:2 to 7:3.

6. The optical film as claimed in claim 1, wherein the first compensation layer has Re of 90 nm to 150 nm at a wavelength of 550 nm.

7. The optical film as claimed in claim 1, wherein the first compensation layer has Rth of 100 nm to 140 nm at a wavelength of 550 nm.

8. The optical film as claimed in claim 1, wherein the first compensation layer has Nz of −1.0 to −0.5 at a wavelength of 550 nm.

9. The optical film as claimed in claim 1, wherein the second compensation layer includes a cellulose or COP film.

10. The optical film as claimed in claim 1, further comprising a polarizing layer stacked on one surface of the second compensation layer.

11. A liquid crystal display, comprising:
a liquid crystal panel including liquid crystals encapsulated between a first substrate and a second substrate;
a first optical film including:
a compensation layer, the compensation layer including a first compensation layer and a second compensation layer stacked on one surface of the first substrate, and
a first polarizing layer stacked on one surface of the compensation layer; and
a second optical film including a second polarizing layer stacked on one surface of the second substrate,
wherein the first compensation layer has a relation of n1z>n1x>n1y between indexes of refraction n1x, n1y, and n1z in x-axis, y-axis, and z-axis directions on a plane, and the second compensation layer has a relation of n2x>n2y>n2z between indexes of refraction n2x, n2y, n2z in x-axis, y-axis, and z-axis directions on a plane.

12. The liquid crystal display as claimed in claim 11, wherein the first compensation layer includes a film obtained by stretching a copolymer of a first repeat unit and a second repeat unit, the first repeat unit including an N-substituted maleimide monomer, an aromatic vinyl monomer, and a maleic anhydride monomer, and the second repeat unit including an aromatic vinyl monomer and a vinyl cyanide monomer.

13. The liquid crystal display as claimed in claim 11, wherein the first compensation layer includes a film obtained by stretching a copolymer represented by Formula 1: 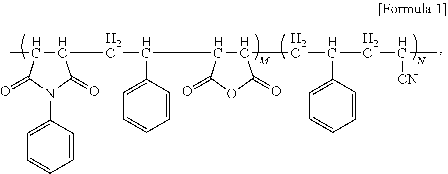
wherein M and N are natural numbers, and M:N is 5:5 to 7:3.

14. The liquid crystal display as claimed in claim 11, wherein the first compensation layer includes a film obtained by stretching a copolymer of an aromatic vinyl monomer and a maleic anhydride monomer.

15. The liquid crystal display as claimed in claim 11, wherein the first compensation layer includes a film obtained by stretching a copolymer represented by Formula 2: 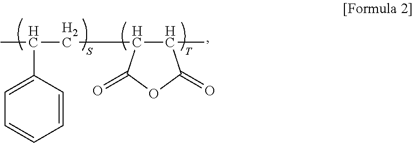
wherein S and T are natural numbers, and S:T is 8:2 to 7:3.

16. The liquid crystal display as claimed in claim 11, wherein the first compensation layer has Re of 90 nm to 150 nm at a wavelength of 550 nm.

17. The liquid crystal display as claimed in claim 11, wherein the first compensation layer has Rth of 100 nm to 140 nm at a wavelength of 550 nm.

18. The liquid crystal display as claimed in claim 11, wherein the first compensation layer has Nz of −1.0 to −0.5 at a wavelength of 550 nm.

19. The liquid crystal display as claimed in claim 11, wherein a retardation axis of the first compensation layer, a retardation axis of the second compensation layer, and a transmission axis of the first polarizing layer are parallel to one another.

20. The liquid crystal display as claimed in claim 11, wherein the second compensation layer includes a cellulose or COP film.

21. The liquid crystal display as claimed in claim 11, wherein the liquid crystals are in-plane switching mode liquid crystals or fringe field switching mode liquid crystals.
